(19) United States
(12) Patent Application Publication
(10) Pub. No.: US 2007/0023560 A1
(43) Pub. Date: Feb. 1, 2007

(54) Apparatus for and method of producing buff tapes

(75) Inventors: Ichiro Kodaka, Berkeley, CA (US); Vuong Van Bang, Milpitas, CA (US); Alvin Timbang, Union City, CA (US)

Correspondence Address: BEYER WEAVER & THOMAS, LLP, P.O. BOX 70250, OAKLAND, CA, 94612-0250, US

(73) Assignee: MIPOX International Corporation

(21) Appl. No.: 11/190,669

(22) Filed: Jul. 26, 2005

(51) Int. Cl. B65H 35/02; B08B 7/00

(52) U.S. Cl. 242/525; 242/530; 15/102; 134/9

(57) ABSTRACT

Buff tapes for smoothing the surface of a magnetic disk substrate are produced by using a slitting device to receive a mother tape having a backing film with a polishing layer formed on its surface and slitting it longitudinally. A guide roller is provided for guiding these buff tapes from the slitting device to take-up rollers for individually winding up the buff tapes and a compression roller serves to compress the buff tapes onto this guide roller with a wiping tape in between to contact the buff tapes from the side of the backing film. The wiping tape is advanced while contacting the buff tapes at a specified depending on the feed speed of the mother tape and the compressive pressure between the guide roller and the compression roller such that 50% to 80% of loose particles of 0.3 μm-5 μm in size can be removed.

### BACKGROUND OF THE INVENTION

This invention relates to an apparatus for and a method of producing buff tapes for smoothing the surface of a magnetic disk substrate and more particularly to an apparatus and method for removing small loose debris particles of 0.3 μm-5 μm in size when such buff tapes are produced from a mother tape by slitting it longitudinally.

A magnetic disk substrate is generally produced by forming layers of metal and magnetic coatings on an aluminum or glass substrate and finally forming a layer of carbon and a lubricating protective over-coating. A surface smoothing process is carried out by using a buff tape (or polishing tape) to remove the abnormal protrusions which are inevitably present as described, for example, in Japanese Patent Publication Tokko 2-10486. A common problem with the use of such a buff tape has been the unwanted presence of small loose particles in the buff tape itself because such small loose particles on the hard disk substrate tend to crash into the magnetic head or become caught under it so as to effectively scratch or become embedded in the disk surface. The major cause of the presence of such loose particles in the buff tape was in its production process, or the process of slitting a mother tape which is produced typically with a width of 100 mm to 1000 mm and is slit longitudinally to obtain individual buff tapes typically having a width of 0.25 inches to 1.5 inches.

Examples of prior art methods for removing such unwanted loose debris particles from buff tapes after obtained by slitting a much wider mother tape include the use of a tacky roller to force the loose particles to get stuck on its surface but the tacky roller material such as including silicon and/or urethane is commonly rejected in the list of materials that may be used or make contact with consumable products for hard disk substrate manufacturing. Another prior art method includes a wiping cloth and a vacuum device to suck up and trap the loose particles in the cloth material but the action of the wiping cloth and the vacuum causes the winding of the rolls to become uneven, loose and/or shifted. Also, the vacuum in a clean room environment upsets the laminar flow of the clean air and effectively causes debris and other particulates to enter the work area.

### SUMMARY OF THE INVENTION

It is therefore an object of this invention to provide an apparatus for and a method of producing buff tapes by simultaneously slitting a mother tape and effectively removing small debris particles in the range of 0.3 μm to 5 μm in size such that the produced buff tapes can be wound up properly without becoming uneven or shifted.

An apparatus according to this invention is characterized as comprising, in addition to a slitting device for receiving a mother tape and slitting it longitudinally to thereby produce a plurality of narrower buff tapes and take-up rollers for individually winding up the buff tapes that have been slit, a guide roller for guiding the slit buff tapes from the slitting device to the take-up rollers, a compression roller for compressing the buff tapes onto this guide roller, and a wiping tape that contacts the buff tapes between the guide roller and the compression roller and serves to thereby remove debris particles from the buff tapes.

In the above, the slitting device may be a device of a know kind such as making use of a male knife and a female knife which rotate with respect to each other and thereby slit the mother tape passed in between. The mother tape is fed to the slitting device at a specified feed speed by a feeding means of a known kind such as a AC motor with a controller, compressing means of a known kind including pneumatic cylinders and a compressed air supply valve is provided for compressing the compression roller against the guide roller with a specified force with the wiping tape and the buff tapes in between, and the wiping tape is advanced in a direction opposite to the motion of the buffer tape by a wiping mechanism that may include a supplying roller and a take-up roller. The speed of the wiping tape is preferably specified according to the feed speed of the mother tape and the compressive pressure between the guide roller and the compression roller for achieving a desired efficiency.

Since experiments have shown that debris particles that are generated by the slitting device tend to be attracted to the PET material of the backing film, the wiping tapes is contacted to the buff tapes from the side of their backing film.

### BRIEF DESCRIPTION OF THE DRAWINGS

FIG. 1 is a schematic drawing of a production apparatus embodying this invention for buff tapes when the wiping tape is not pressed against the buff tapes.

FIG. 2 is a sectional view of a portion of the production apparatus of FIG. 1 including the guide roller and the compression roller with the mechanism for moving the compression roller towards and away from the guide roller.

FIG. 3 is a schematic drawing of a portion of the production apparatus of FIG. 1 when the wiping tape is pressed against the buff tape through the motion of the compression roller.

### DETAILED DESCRIPTION OF THE INVENTION

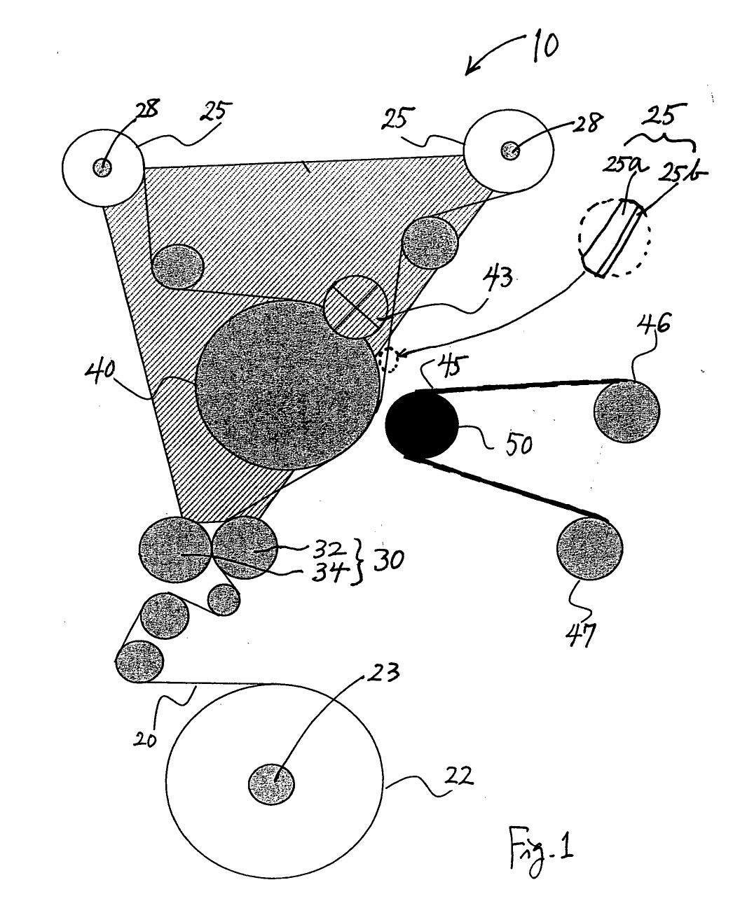

FIG. 1 is a schematic of a production apparatus 10 embodying this invention. Explained in most basic terms, buff tapes are produced according to this invention by slitting a mother tape 20 longitudinally into a plurality of strips and by winding up these slit stripes. The mother tape 20 is basically of the same structure as the target buff tapes 25 to be produced, having a backing film 25b of a suitable material such as PET with a suitable thickness and coated with abrading particles such as aluminum oxide particles of a desired size such as 0.1-5.0 μm mixed in a urethane binder and dried to form a polishing layer 25a, different from the target buff tapes to be produced essentially in that it is much wider. The mother tape 20 is typically produced and provided in the form of a roll, or a web 22, typically having a width of 100 mm to 1000 mm and a length of 100 m to 1000 m, and is mounted to a feed roller 23, from which it is unwound and fed to a slitting device 30.

The slitting device 30 may be of a conventionally known kind, for example, comprising a male knife 34 and a female knife 32 which engage with respect to each other and between which the mother tape 20 unwound from the web 22 is fed, the peripheral speed of the male knife 34 being 1.01-1.20 times greater than that of the female knife 32, for example, such that the mother tape 20 fed in between is slit thereby into a plurality of buff tapes 25 each with a specified width, say, in a typical range of 0.25 to 1.5 inches. The buff tapes 25, into which the mother tape 20 is thus slit longitudinally by means of the slitting device 30, are individually wound up around take-up rollers 28. Although two separate rollers 28 are shown in FIG. 1 for clearly showing that a plurality of buffer tapes 25 are individually being produced, the produced plurality of buff tapes 25 may be adapted to be wound up around a single roller to be taken up.

A guide roller 40 with a polished steel surface is provided between the slitting device 30 and the take-up rollers 28 for guiding the slit buff tapes 25 from the slitting device 30 to the take-up rollers 28 by contacting the surface of the tapes coated with the particles. An AC motor 43 with a controller is provided for driving the slitting device 30, the guide roller 40 and the take-up roller 28 through interconnecting means such as a series of gears, brakes and timing belts (not shown), corresponding to the feed speed of the mother tape 20 to the slitting device 30. Such a mechanism for controlling the feed speed is well known and is not intended to limit the scope of the invention.

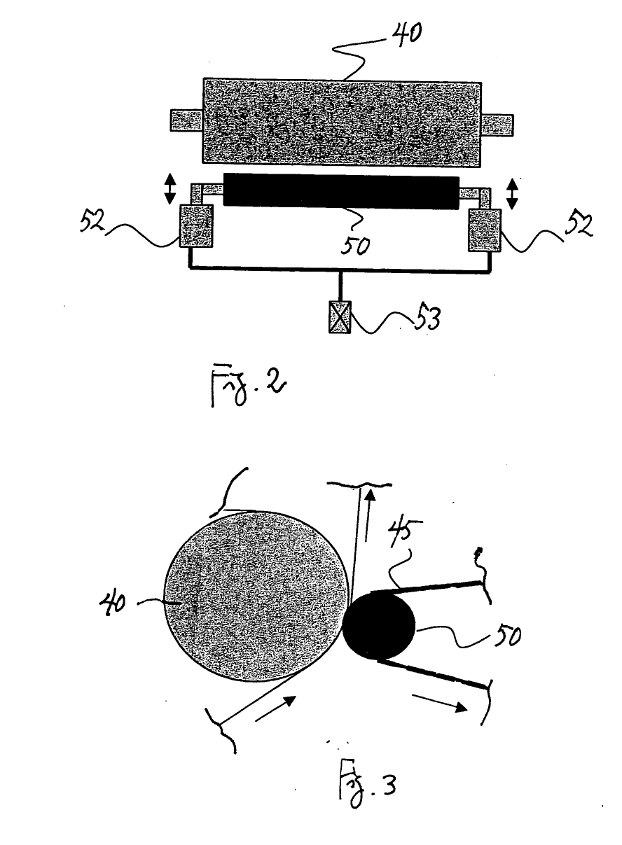

As shown both in FIGS. 1 and 2, a compression roller 50 having a compressible peripheral surface with hardness of Shore A 50-70 Durometers is provided proximally to the portion of the surface of the guide roller 40 where the buff tapes 25 are in contact. A mechanism, such as comprising pneumatic cylinders 52 along with a compressed air supply valve 53, is provided for moving the compression roller 50 towards the guide roller 40 such that a specified pressure may be applied as shown in FIG. 3, and also away from the guide roller 40 to a retracted position as shown in FIG. 1.

A wiping tape 45 of a material such as a clean-room approved wiping cloth of polyester or nylon commonly used as a consumable product for direct or indirect contact use with a hard disk substrate surface is unwound from a supply roller 46, threaded around the compression roller 50 where it contacts the guide roller 40 and rewound by a take-up roller 47 such that, as the compression roller 50 is moved towards the guiding roller by the operation of the pneumatic cylinders 52 serving as its moving mechanism, the wiping tape 45 contacts the buff tapes 25 on the side of their backing film 25b.

A method of using such an apparatus embodying this invention will be described next. As the controller for the AC motor 43 is operated, the mother tape 20 is fed to the slitting device 30 and the buff tapes 25 thereby slit are individually wound up around the take-up rollers 28 at a specified feed speed. The male knife 34 and the female knife 32 of the slitting device 30 are each rotated at a conveniently specified rate as will be explained more in detail below.

As the mother tape 20 is split into the buff tapes 25, many loose debris particles are generated which are harmful and hence should be removed, as explained above. For this purpose, the wiping tape 45 is pressed onto the buff tapes 25 between the guide roller 40 and the compression roller 50 on the downstream side of the slitting device 30. The wiping tape 45 contacts the buff tapes 25 across the entire width and from the side of the backing film 25b because experiments have shown that the loose particles to be removed according to this invention are mostly attracted to the PET material of the backing film 25b due to the electrostatic charge of the buff tapes 25.

As the compressive pressure with which the compression roller 50 is pressed against the guide roller 40 with the buff tapes 25 and the wiping tape 45 contacting each other and sandwiched therebetween by means of the pneumatic cylinders 52 and the compressed air supply valve 53, the wiping tape 45 is advanced over the contacting surface of the compression roller 50 in the direction opposite to the motion of the buff tapes 25 by being unwound from the supply roller 46 and rewound around the take-up roller 47 at a specified supply rate. This supply rate is optimally determined according to other operational conditions such as the feed speed of the mother tape 20 and the compressive pressure between the compression.

These operational parameters should be carefully selected also for the purpose of effectively winding up the buff tapes 25 around the take-up rollers 28. The feed speed of the mother tape 20 should be greater than 10 m/min from the point of view of the minimally acceptable productivity and should preferably be less than 30 m/min from the point of view of the minimally acceptable winding quality for buff tapes 25 with a width of 1.375 inches. For feed speeds between these minimum and maximum value, Table 1 shows some representative examples of preferred combination of the supply rate of the wiping tape 45 and the compressive pressure between the guide roller 40 and the compression roller 50 in the case of a compression roller with surface hardness of Shore A 50-70 Durometers for collecting debris particles of size of 0.3 to 5.0 μm on a 1 mil-PET backing film.

TABLE 1

| | | Compressive pressure |
|---|---|---|
| Feed speed of | Supply rate of | between guide roller and |
| mother tape | wiping tape | compression roller (kg/cm²) |
| 10 m/min | 15 mm/min | 2 kg/cm² |
| 15 m/min | 22.5 mm/min | 1.75 kg/cm² |
| 20 m/min | 30 mm/min | 1.5 kg/cm² |
| 25 m/min | 37.5 mm/min | 1.25 kg/cm² |
| 30 m/min | 45 mm/min | 1 kg/cm² |

It is to be reminded, however, that these combinations are merely illustrative examples and not intended to limit the scope of the invention. Experiments have shown that a reduction of loose particles by 50% to 80% could be achieved by a method of this invention.

What is claimed is:

1. An apparatus for producing buff tapes, said apparatus comprising:
a slitting device for receiving a mother tape and slitting said received mother tape longitudinally to thereby produce a plurality of buff tapes;
take-up rollers for individually taking up said buff tapes;
a guide roller for guiding said buff tapes from said slitting device to said take-up rollers;
a compression roller for compressing said buff tapes onto said guide roller; and
a wiping tape that contacts said buff tapes between said guide roller and said compression roller and serves to thereby remove debris particles from said buff tapes.

2. The apparatus of claim 1 further comprising compressing means for compressing said compression roller against said guide roller with a specified force with said wiping tape and said buff tapes in between.

3. The apparatus of claim 1 further comprising feeding means for feeding said mother tape to said slitting device at a specified feed speed.

4. The apparatus of claim 1 further comprising a wiping mechanism for causing said wiping tape to advance at a specified rate.

5. The apparatus of claim 4 wherein said wiping mechanism includes a pair of rollers for unwinding and rewinding said wiping tape while causing said wiping tape to advance at said specified rate.

6. The apparatus of claim 4 further comprising feeding means for feeding said mother tape to said slitting device at a specified feed speed, wherein said specified rate is determined from said feed speed and the pressure between said guide roller and said compression roller.

7. The apparatus of claim 1 wherein said mother tape comprises a backing film coated with abrading particles of 0.1-5.0 μm in size.

8. The apparatus of claim 7 wherein said wiping tape contacts said backing film between said guide roller and said compression roller.

9. The apparatus of claim 1 wherein said compression roller has a surface hardness of Shore A 50-70 durometers.

10. A method of producing buff tapes, said method comprising the steps of:
feeding a mother tape having backing film coated with abrading particles to a slitting device at a specified feed speed;
using said slitting device to slit said mother tape longitudinally to obtain a plurality of buff tapes;
taking up said slit buff tapes individually around take-up rollers;
providing a guide roller between said take-up rollers and said slitting device for guiding said buff tapes from said slitting device towards said take-up rollers;
compressing said buff tapes against said guide roller with a compression roller; and
providing a wiping tape compressed against said buff tapes between said guiding roller and said compression roller to thereby remove debris particles from said buff tapes.

11. The method of claim 10 further comprising the step of advancing said wiping tape at a specified rate.

12. The method of claim 11 wherein said specified rate is determined from said feed speed and the pressure between said compression roller and said guide roller.

13. The method of claim 10 wherein said mother tape comprises a backing film coated with abrading particles of 0.1-5.0 μm in size.

14. The method of claim 13 wherein said wiping tape contacts said backing film between said guide roller and said compression roller.

15. The method of claim 12 wherein said feed speed is 10 m/min-30 m/min, said specified rate is 15 mm/min-45 mm/min and said compression roller is compressed against said guide roller with a pressure of 1 kg/cm²-2 kg/cm².

16. The method of claim 10 wherein 50% to 80% of loose particles of 0.3 μm to 5 μm are removed from said buff tapes by said wiping tape.
